(19) United States
(12) Patent Application Publication
(10) Pub. No.: US 2010/0327808 A1
(43) Pub. Date: Dec. 30, 2010

(54) CONTROL UNIT

(75) Inventors: Kimihiro MATSUURA, Makinohara-shi (JP); Masashi SEKIZAKI, Makinohara-shi (JP); Masahiro HASEGAWA, Makinohara-shi (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 12/783,626

(22) Filed: May 20, 2010

(30) Foreign Application Priority Data
Jun. 25, 2009 (JP) 2009-151147

(51) Int. Cl. H02J 7/00

(52) U.S. Cl. 320/118

(57) ABSTRACT

A control unit includes a control device that outputs a first command signal to an equalizing unit, which has a discharge circuit for solving a dispersion of cell voltage in respective cells of a battery and a switch unit for connecting the discharge circuit to at least one of the cells, and a command signal outputting circuit that outputs a second command signal to the equalizing unit so that a connection between the discharge circuit and the at least one of the cells is forcibly disconnected, when an abnormal operation of the control device, disabling an output of the first command signal, is detected. When the equalizing unit receives the first command signal, the discharge circuit is connected to the at least one of the cells by the switch unit to discharge the at least one of the cells.

### BACKGROUND

The present invention relates to a control unit which controls a discharging operation by an equalizing unit for conducting an equalizing process to solve dispersion (variation) of electric voltage in a plurality of cells in a battery pack, by a control device.

A hybrid vehicle, for example, is provided with a high voltage battery as a driving power source for a motor. The high voltage battery is composed of a plurality of unit cells of a secondary battery (storage type battery) such as a nickel metal hydride battery, a lithium-based battery which are connected in series thereby to obtain a high electric voltage.

In the high voltage battery in a form of such a battery pack, it is necessary to confirm a charged state of each of the unit cells so that the secondary battery may not be over-discharged or over-charged. Therefore, it has been conventionally conducted to measure the voltage of each of the unit cells at real time, and to judge whether or not the voltage of each of the unit cells which has been measured is within a determined range.

Moreover, in case where charging and discharging are repeated for a long time in the high voltage battery, or the high voltage battery is left untouched for a long time, remaining capacitance of electric power becomes inconsistent among the unit cells, in some cases. In the high voltage battery in which the remaining capacitance has become inconsistent among the unit cells, when the unit cell having the largest remaining capacitance reaches an upper limit, the charging is stopped for preventing over-charge. When the unit cell having the smallest remaining capacitance reaches a lower limit, the discharging is stopped for preventing over-discharge. In short, when the remaining capacitance has become inconsistent among the unit cells of the high voltage battery, the capacitance available to be used in the entire high voltage battery is decreased, and a sufficient electric power cannot be obtained from the high voltage battery.

Under the circumstances, it has been heretofore conducted that the unit cell having the higher voltage out of the unit cells which have been measured is selectively discharged by operating an equalizing unit, thereby to equalize the remaining capacitances in all the unit cells (JP-A-2000-92732, for example).

In the related case as described above, an on-off operation of a switch which selectively connects each of the unit cells to a discharge circuit in the equalizing unit is controlled by a control device (microcomputer) at a low voltage side which is insulated from a high voltage side, via a photo-coupler.

When this control device has run away due to occurrence of a trouble in the control device while the equalizing operation is carried out (a specific unit cell is selectively discharged), the unit cell which has started to be selectively discharged by the control prior to the runaway cannot be shut off from the discharge circuit. Consequently, the specific unit cell which is connected to the discharge circuit continues to be discharged endlessly, and at last, the power will be lost, until the high voltage battery is totally exhausted.

### SUMMARY

The invention has been made in view of the above described circumstances, and it is an object of the invention to provide a control unit in which a unit cell can be prevented from being continuously discharged by a discharge circuit, even in case where a runaway has occurred in a control device of an equalizing unit in a state where the unit cell is connected to the discharge circuit.

In order to achieve the above object, according to the present invention, there is provided a control unit comprising:

a control device that outputs a first command signal to an equalizing unit, which has a discharge circuit for solving a dispersion of cell voltage in respective cells of a battery and a switch unit for connecting the discharge circuit to at least one of the cells, wherein when the equalizing unit receives the first command signal, the discharge circuit is connected to the at least one of the cells by the switch unit to discharge the at least one of the cells; and

a command signal outputting circuit that outputs a second command signal to the equalizing unit so that a connection between the discharge circuit and the at least one of the cells is forcibly disconnected, when an abnormal operation of the control device, disabling an output of the first command signal, is detected.

Preferably, the battery is a power source for a driving motor of a vehicle. The control device controls an operation of the equalizing unit so that the discharge circuit is connected to the at least one of the cells by the switch unit to discharge the at least one of the cells based on the first command signal when an ignition switch of the vehicle is an off state.

Preferably, the control unit further includes a reset circuit that outputs to the control device a reset signal for resetting an operation of the control device when the control device is in the abnormal operation. The command signal outputting circuit detects the abnormal operation of the control device, when it is detected that the control device has not been reset by the reset signal.

According to the above configuration, the command signal outputting circuit is “the circuit” which does not require a program in operation. Therefore, even though a program for controlling the operation of the equalizing unit does not function due to the abnormal operation of the control device, the command signal outputting circuit reliably generates and outputs the second command signal instead of the control device in which the program does not function. According to the second command signal, the cell which is connected to the discharge circuit in the equalizing unit is forcibly disconnected from the discharge circuit. In this manner, it is possible to prevent the specific cell of the battery from continuing to be discharged uselessly, during the abnormal operation of the control device.

Also, by the above configuration, the abnormal operation of the control device cannot be dealt with, based on operation of a high level controller, because the high level controller is not operated while the ignition switch of the vehicle is in the off state. However, the command signal outputting circuit which does not require the program in operation since it is “the circuit” can output the second command signal for forcibly disconnecting the cell which is connected to the discharge circuit in the equalizing unit from the discharge circuit, irrespective of whether the ignition switch is in the on state or the off state. Therefore, even in such a structure that the equalizing operation of the cell voltages is conducted by the equalizing unit while the ignition switch is off, it is possible to prevent the specific cell of the battery from continuing to be discharged uselessly, during the abnormal operation of the control device.

Also, by the above configuration, even while the ignition switch is in the off state and the high level controller of the control unit is not operated, the reset device outputs the reset signal when the abnormal operation of the control device has occurred. For this reason, in case where the control device during the abnormal operation is reset by the reset signal, it is possible to allow the control device to forcibly disconnect the cell which has been connected to the discharge circuit in the equalizing unit, from the discharge circuit by this rest. Moreover, even though the control device during the abnormal operation is not reset by the reset signal, it is possible to forcibly disconnect the cell which has been connected to the discharge circuit, from the discharge circuit, by the command signal which is outputted from the command signal outputting circuit. Therefore, even while the ignition switch is in the off state, it is possible to reliably prevent the specific cell of the battery pack from continuing to be discharged uselessly, during the abnormal operation of the control device.

According to the control unit of the invention, it is possible to prevent the specific cell of the battery pack from continuing to be discharged uselessly, during the abnormal operation of the control device.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing a schematic electrical structure of an electric voltage control system in which a control unit in an embodiment according to the invention is used for controlling an equalizing unit of a battery pack.

### DETAILED DESCRIPTION OF EXEMPLARY EMBODIMENTS

A control unit in an embodiment according to the invention will be described referring to the drawing.

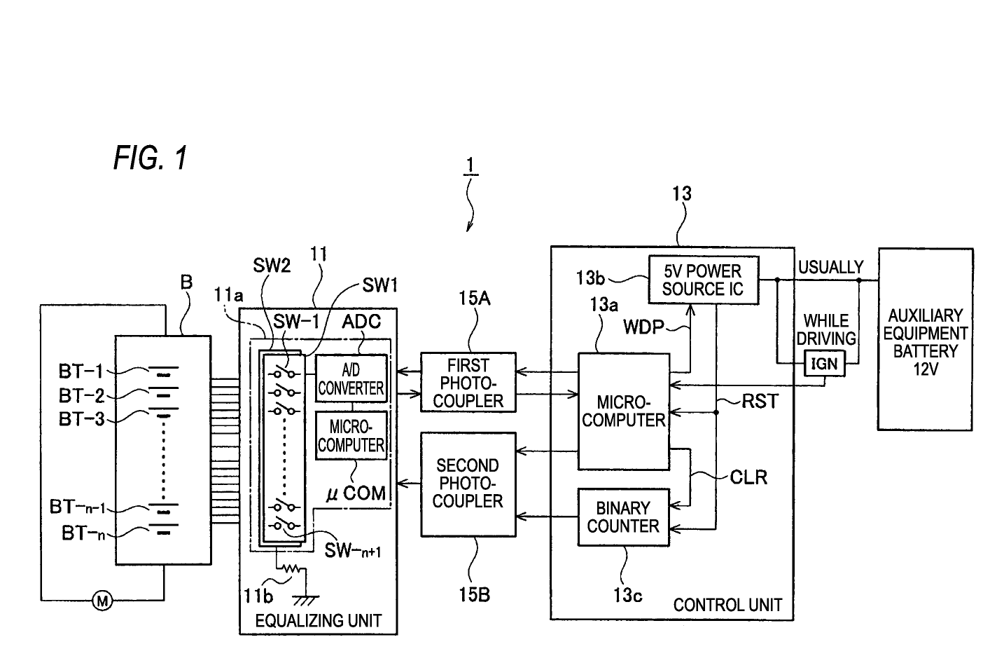

FIG. 1 is a block diagram showing a schematic electrical structure of an electric voltage control system in which a control unit in an embodiment according to the invention is used for controlling an equalizing unit of a battery pack. The electric voltage control system 1 in FIG. 1 controls electric voltage of a battery pack (a secondary battery) B. In the battery pack, a plurality of unit cells BT-1 to BT-n (corresponding to the cells) such as lithium-based batteries are connected in series. The battery pack B is used as a power source for a driving motor M of a vehicle (not shown). The electric voltage control system 1 has an equalizing unit 11 for monitoring and equalizing electric voltages of the unit cells BT-1 to BT-n, and a control unit 13 for controlling operation of the equalizing unit 11. The equalizing unit 11 and the control unit 13 are connected to each other by two photo-couplers, namely, first and second photo-couplers 15A, 15B.

The equalizing unit 11 has a custom IC 11a and a discharge circuit 11b. The custom IC 11a incorporates therein two groups of switch sections SW1, SW2 for selecting a desired unit cell BT-1 to BT-n of the battery pack B, an A/D converter ADC for measuring the voltage across the unit cell BT-1 to BT-n which has been selected by one of the switch sections SW1, and a one chip microcomputer COM.

The switch sections SW1 and SW2 respectively have a plurality of switches SW-1 to SW-n+1 each formed of a photo MOS transistor. The switches SW-1 to SW-n+1 of the respective switch sections SW1, SW2 are connected to a connection point between electrodes of the adjacent unit cells BT-1 to BT-n, and to electrodes of the unit cells BT-1 and BT-n which are positioned at both ends of the battery pack B.

To the microcomputer COM, a command signal for measuring cell voltage and a command signal for equalizing operation are inputted from the control unit 13 via the first photo-coupler 15A, during normal operation of the control unit. Moreover, a command signal for announcing an abnormal condition is inputted to the microcomputer COM from the control unit 13, when the abnormal condition has occurred in operation.

When the command signal for measuring the cell voltage is inputted to the microcomputer COM, the microcomputer COM carries out the cell voltage measuring operation. In this cell voltage measuring operation, the microcomputer COM connects or disconnects the unit cell BT-1 to BT-n which has been designated by the command signal for measuring the cell voltage, with respect to the ND converter ADC. In this manner, the microcomputer COM measures the voltages across the unit cells BT-1 to BT-n which are sequentially connected to the A/D converter ADC, respectively, on the basis of digital outputs of the ND converter ADC. Then, the microcomputer COM outputs the voltages across the unit cells BT-1 to BT-n which have been measured, to the control unit 13 via the first photo-coupler 15A.

When the command signal for equalizing operation is inputted to the microcomputer COM, the microcomputer COM carries out the equalizing operation. In this equalizing operation, the microcomputer COM connects or disconnects the unit cell BT-1 to BT-n which has been designated by the command signal for equalizing operation, with respect to the discharge circuit 11b, by switching on or off the other switch section SW2. In this manner, the microcomputer COM connects the other unit cells BT-1 to BT-n except the unit cell BT-1 to BT-n having the lowest voltage across the unit cell, to the discharge circuit 11b to be discharged, until the voltages across the other unit cells BT-1 to BT-n become consistent with the voltage across the unit cell BT-1 to BT-n having the lowest voltage. Therefore, in this embodiment, the switches SW-1 to SW-n+1 of the switch section SW2 correspond to the switches.

When the command signal for announcing an abnormal condition is inputted to the microcomputer COM, the microcomputer COM forcibly turns off all the switches SW-1 to SW-n+1 of the switch sections SW1, SW2.

The control unit 13 has a microcomputer 13a, a 5V power source IC 13b, and a binary counter 13c. An ignition switch IGN is connected to the microcomputer 13a.

The microcomputer 13a (corresponding to the control device) is brought into a power saving mode or an equalizing mode, when the ignition switch IGN is switched from on to off. Also, the microcomputer 13a is brought into a normal mode, when the ignition switch IGN is switched from the off state to the on state. Moreover, the microcomputer 13a outputs a watch dog pulse WDP at a constant cycle during the normal operation, irrespective of on state and off state of the ignition switch IGN and the current mode of the microcomputer 13a.

In case where the watch dog pulse WDP is not inputted to the 5V power source IC 13b from the microcomputer 13a for a determined time since a previous input or an output of a reset signal RST, the 5V power source IC 13b (corresponding to the reset circuit) outputs the reset signal RST to the microcomputer 13a and the binary counter 13c. When the reset signal RST is inputted to the microcomputer 13a from the 5V power source IC 13b, the microcomputer 13a is reset to be restarted, and brought into the normal mode.

The binary counter 13c (corresponding to the command signal outputting circuit) counts the number of the outputs of the reset signal RST from the 5V power source IC 13b. The counted value is reset to be zero by a counter clear signal CLR which is outputted from the microcomputer 13a. This counter clear signal CLR is outputted from the microcomputer 13a, when the microcomputer 13a is reset and restarted along with the input of the reset signal RST from the 5V power source IC 13b. When the counted value of the reset signal RST has reached a determined value, the binary counter 13c outputs the command signal for announcing an abnormal condition to the microcomputer COM in the equalizing unit 11 via the second photo-coupler 15B. The above described determined value which is set for the counted value of the binary counter 13c can be set at an integer of more than 1. In short, it may be once, or may be twice or more.

The microcomputer 13a switches off all the switches SW-1 to SW-n+1 of the respective switch sections SW1, SW2 as an initializing operation, when the microcomputer 13a has been shifted to the normal mode from the other mode, that is, when the ignition switch IGN has been switched from the off state to the on state.

In the normal mode, the microcomputer 13a outputs the command signal for measuring the cell voltage to the equalizing unit 11 at a constant cycle, via the first photo-coupler 15A. With this command signal for measuring the cell voltage, the microcomputer 13a designates the unit cell BT-1 to BT-n of which the voltage across the unit cell is to be measured. After the microcomputer 13a has outputted the command signal for measuring the cell voltage, the microcomputer 13a outputs the voltages across the respective unit cells BT-1 to BT-n which have been measured by the equalizing unit 11 to a higher level controller (not shown, for example, an ECU of the vehicle) for monitoring the voltage of the battery pack B, through a local area network which is not shown.

Further, in case where a signal for requiring the equalization is inputted from a high level controller (not shown), in the normal mode, the microcomputer 13a is shifted from the normal mode to the equalizing mode, along with the switching operation of the ignition switch IGN from the on state to the off state. On the other hand, in case where the signal for requiring the equalization is not inputted in the normal mode, the microcomputer 13a is shifted from the normal mode to the power saving mode, along with the switching operation of the ignition switch IGN from the on state to the off state. The signal for requiring the equalization is inputted from the high level controller to the microcomputer 13a, when the high level controller has judged that the unit cells BT-1 to BT-n must be equalized, on the basis of the results of measurement of the voltages across the respective unit cells BT-1 to BT-n which have been inputted from the microcomputer 13a.

In the power saving mode, the microcomputer 13a is in a sleeping state, until it is shifted to the normal mode, by switching the ignition switch IGN from the off state to the on state.

In the equalizing mode, the microcomputer 13a outputs the command signal for the equalizing operation to the equalizing unit 11, until the ignition switch IGN is switched from the off state to the on state and the microcomputer 13a is shifted to the normal mode. This command signal is a signal for sequentially connecting the unit cells BT-1 to BT-n which need to be equalized to the discharge circuit 11b in the equalizing unit 11 for allowing the unit cells to be discharged. Therefore, with the command signal for the equalizing operation, one of the unit cells BT-1 to BT-n which are requested to be equalized by the signal for requiring the equalization from the high level controller is designated, and also, connection or disconnection of the designated unit cell with respect to the discharge circuit 11b in the equalizing unit 11 is commanded.

Further, the command signal for connecting the unit cell BT-1 to BT-n which has been designated to the discharge circuit 11b, and the command signal for disconnecting this unit cell BT-1 to BT-n from the discharge circuit 11b are outputted to the equalizing unit 11, interposing a time interval corresponding to a discharging amount required for the unit cell BT-1 to BT-n which has been designated as an object to be connected to the discharge circuit 11b. During the time interval of the output before and after the command signal, the microcomputer 13a is in a sleeping state which is substantially the same as the power saving mode.

In the control unit 13 in the above described embodiment, in case where the microcomputer 13a has run away for some reason, the microcomputer 13a will be reset (restarted) by the reset signal RST which is outputted from the 5V power source IC 13b where the watch dog pulse is not inputted, in one case, and the microcomputer 13a will not be reset (restarted), in another case.

In case where the microcomputer 13a is reset by the reset signal RST, all the switches SW-1 to SW-n+1 of the switch section SW2 are switched off by the initializing operation of the microcomputer 13a which is shifted to the normal mode, by restarting afterward. Therefore, the unit cells BT-1 to BT-n will not continue to be discharged uselessly in the discharge circuit 11b, due to the runaway of the microcomputer 13a.

On the other hand, in case where the microcomputer 13a is not reset by the reset signal RST, the watch dog pulse is not outputted from the microcomputer 13a due to the runaway, and the reset signals RST are repeatedly outputted from the 5V power source IC 13b, while the microcomputer 13a is not reset (restarted). When the number of the outputs of the reset signals RST has reached the determined value, it is judged that the microcomputer 13a is not reset by the reset signal RST, and all the switches SW-1 to SW-n+1 of the switch section SW2 are switched off by the command signal for announcing an abnormal condition outputted from the binary counter 13c. Therefore, the respective unit cells BT-1 to BT-n will not continue to be discharged uselessly in the discharge circuit 11b, due to the runaway of the microcomputer 13a, even in case where the microcomputer 13a which has run away is not reset.

For this reason, even though the runaway of the microcomputer 13a in the control unit 13 which controls on and off of the switches SW-1 to SW-n+1 of the switch section SW2 in the equalizing unit 11 has occurred, in a state where the unit cells BT-1 to BT-n of the battery pack B are connected to the discharge circuit 11b, it is possible to prevent the unit cells BT-1 to BT-n from being kept connected to the discharge circuit 11b to continue to be discharged uselessly. As the results, it is possible to prevent occurrence of exhaustion and damage of the battery pack B due to over discharge of the unit cells BT-1 to BT-n.

In this embodiment, the case where the battery pack B is used as the power source for the driving motor M of the vehicle has been described, as an example. However, it is also possible to apply the invention to a battery pack which is used as a power source for other motors than the driving motor of a vehicle.

Moreover, in this embodiment, the case where the equalizing operation of the unit cells BT-1 to BT-n of the battery pack B by the equalizing unit 11 is carried out, while the ignition switch IGN is off, has been described, as an example. However, it is also possible to apply the invention to such a battery pack that the equalizing operation of the unit cells BT-1 to BT-n is carried out, while the ignition switch IGN is on.

This invention is favorably used in case where the discharging operation of the equalizing unit which conducts the equalizing process for the purpose of solving dispersion of the voltage in a plurality of cells composing the battery pack by discharging is controlled by the control device in the control unit.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japanese Patent Application No. 2009-151147 filed on Jun. 25, 2009, the contents of which are incorporated herein by reference.

What is claimed is:

1. A control unit comprising:
a control device that outputs a first command signal to an equalizing unit, which has a discharge circuit for solving a dispersion of cell voltage in respective cells of a battery and a switch unit for connecting the discharge circuit to at least one of the cells, wherein when the equalizing unit receives the first command signal, the discharge circuit is connected to the at least one of the cells by the switch unit to discharge the at least one of the cells; and
a command signal outputting circuit that outputs a second command signal to the equalizing unit so that a connection between the discharge circuit and the at least one of the cells is forcibly disconnected, when an abnormal operation of the control device, disabling an output of the first command signal, is detected.

2. The control unit according to claim 1, wherein the battery is a power source for a driving motor of a vehicle; and
wherein the control device controls an operation of the equalizing unit so that the discharge circuit is connected to the at least one of the cells by the switch unit to discharge the at least one of the cells based on the first command signal when an ignition switch of the vehicle is in an off state.

3. The control unit according to claim 1, further comprising:
a reset circuit that outputs to the control device a reset signal for resetting an operation of the control device when the control device is in the abnormal operation,
wherein the command signal outputting circuit detects the abnormal operation of the control device, when it is detected that the control device has not been reset by the reset signal.
